(19) United States
(12) Patent Application Publication
(10) Pub. No.: US 2001/0050998 A1
(43) Pub. Date: Dec. 13, 2001

(54) SYSTEM AND METHOD FOR PREPARING PRINTING MEMBERS

(76) Inventors: LIZI FIRAN, EVEN YEHUDA (IL); ORI BELKIND, HAR ADAR (IL); IIAN BARAK, HADERA (IL)

Correspondence Address: EITAN, PEARL, LATZER & COHEN-ZEDEK, C/O JOHN L. WELSH, AQUILINO, WELSH & FLAXMAN, 2341 JEFFERSON DAVIS HIGHWAY, SUITE 112, ARLINGTON, VA, 22202, US

(21) Appl. No.: 09/089,582

(22) Filed: Jun. 3, 1998

(30) Foreign Application Priority Data
Jun. 3, 1997 (IL) 120986

(51) Int. Cl. G06K 9/00

(52) U.S. Cl. 382/112

(57) ABSTRACT

A system and method for printing member re-makes in CTP systems is disclosed. According to one aspect of the invention, a code associated with the digital data representing the content image thereof and with the printing member's status, is printed on the printing member produced by the CTP system. Once the printing member is produced, its quality is examined manually or automatically on-system or off the system. If not satisfactory the code enables easier retrieval of the digital information to be recorded on the printing member and thus more efficient remake thereof.

### FIELD AND BACKGROUND OF THE INVENTION

The present invention relates to Computer To Plate (CTP) image setters and on-press imaging systems. Traditionally, in the pre-press industry, printing members to be used in a printing press are recorded by a contact process from a photographic film produced by a laser plotter, the film including a half tone image representing the original image to be subsequently reproduced in the printing press. In the last decade, it has been realized that the digital representation of an image to be reproduced in a printing press may be recorded directly on a printing member, thus obviating the use of films. This process is usually termed computer to plate or computer to press, both usually referred to as CTP.

In computer to plate process, the printing member is produced directly by a plate setter, such as the Lotem 800, commercially available from Scitex Corporation Ltd. of Herzelia, Israel. In the computer to press process, the printing member is produced on a digital press, in particular in a digital lithographic press, such as the Quick Master D146-4, commercially available from Heidelberg Druckmachinen of Germany. In this process, the image is recorded on the printing member on-press, i.e. while the printing plate is mounted on the printing press.

The computer to plate technology has the advantage of shortening the prepress procedure by eliminating the production of film, and exposing from a computer front end directly to plate. The imaging data is digital all through the CTP workflow and a streamlined automated procedure is both feasible and necessary.

An automated and streamlined workflow requires a simple to use and efficient interface with non-prepress operators. Non-prepress operators may provide necessary workflow and status information, such as in-house and customer proof and improof approvals, plate remake request, file storage status change and retrieve from digital archiving. The status of plates includes whether plates are approved, waiting for press, mounted on press, or removed from press.

Currently, CTP workflows include modules such as the Brisque front end which converts image files from digital databases and archives and exposes the files to a plate setter, such as the Lotem 800, commercially available from the assignee of the present invention.

At present, if a flow needs to continue, or a part of a flow needs to be repeated, such as for a correction cycle, only skilled front end operators can initiate a process by locating the correct files and performing the prepress procedure. It requires skilled prepress operators, and manual management efforts which is prone to error, to carry out the necessary prepress procedures. A press which is located far from the prepress section will make any intervention in the prepress procedures time consuming and inconvenient.

### SUMMARY OF THE INVENTION

The present invention provides a system and method for printing member re-makes in CTP systems.

It is an object of the present invention to utilize bar codes to automate the preset prepress procedure. Bar codes are known for use in the printing industry for specific applications, such as for example, the control and management of the printing job after it has left the prepress section. These bar codes are paper labels that are stuck onto the job's sleeve. Another usage has been in the field of automated imposition with the aid of Step and Repeat machines. In this case, the bar codes are exposed on film and used for automatic placement of images as an impositioning solution.

According to one aspect of the invention, a code, such as a bar code is printed on the printing member produced by the CTP system. Once the printing member is produced, its quality is examined manually or automatically on-system or off the system. If not satisfactory the code enables easier retrieval of the digital information to be recorded on the printing member and thus more efficient remake thereof.

In the present invention the term printing member includes, but is not limited to plate, film, paper and also includes proof and improof.

In one aspect of the present invention, there is provided a method for producing a printing member acceptable for printing which includes the steps of exposing a first printing member with a code associated with the digital data representing the content image thereof, determining whether said first printing member meets a quality suitable for printing, and remaking said printing member to expose a second printing member utilizing said code to retrieve said digital data representing the content image. The code also includes an indication of the status of the printing member.

The content image refers herein to the actual image to be printed and the parameters defining to the CTP system the way the image should be exposed. These parameters include the screen parameters, proof procedure parameters, imposition parameters and the like all well known in the digital pre-press industry.

In one embodiment, the step of exposing includes exposing the first printing member by a plate setter or on-press and the determining includes the step inspecting the first printing member to determine its quality manually or automatically.

Additionally, the method may include the step of archiving said data representing the content Image along with said code in a digital or paper archiver. Alternatively, the data can be stored at the front end of a CTP system for later retrieval.

Furthermore, according to an embodiment of the invention, the reading of the coded data at the front end can automatically call up the printing member to be re-printed.

In operation according to an embodiment of the invention the step of utilizing includes reading the code, preferably but not necessarily a bar code, of the first printing member, thereby triggering the retrieval of said digital data representing the content image.

In one embodiment, the code includes an ID portion and a Status portion. The reading of the ID portion together with a specific “Archive” status triggers the archiving. Reading the ID portion together with a “Remake” status triggers the remake of the plate.

In addition, according to an embodiment of the invention, a proof or improof is prepared prior to exposure of the printing member. The method for creating the proof is similar to that described for a printing member, that is digital information representation of the proof/improof is generated and the proof/improof bar codes are output. The ID and status is read and if a proof has failed, it is corrected before continuing with the workflow for exposing the printing member.

The present invention also provides a CTP system operative in accordance with the methods of the invention and printing members produced in accordance with the methods of the invention and by the CTP system thereof.

### BRIEF DESCRIPTION OF THE DRAWINGS

The present invention will be understood and appreciated more fully from the following detailed description taken in conjunction with the appended drawings in which:

FIG. 1 is a schematic pictorial illustration of a CTP system according to one embodiment of the present invention;

FIG. 2 is an exemplary printing member with the code of the present invention;

FIG. 3 is a schematic flow chart of the re-make process of the present invention; and

FIG. 4 is a schematic flow chart of the proofing process of the present invention.

### DETAILED DESCRIPTION OF THE PRESENT INVENTION

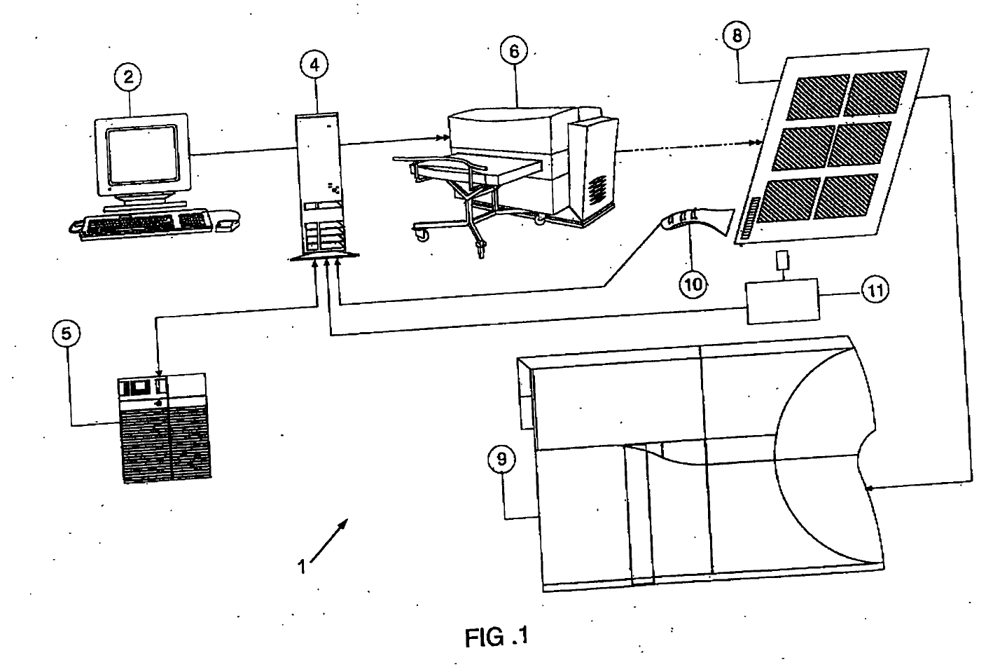

Reference is now made to FIG. 1 which illustrates a CTP system according to the present invention. The CTP system, generally referenced 1 includes a front end console 2, a front end module 4, a digital archiving system 5, a plate setter 6 operative to produce printing members 8 to be used in printing press 9 and a bar code reader 10. All parts of the system are commercially available, for example one may use the Brisque front end with the Ripro digital archiver commercially available from the assignee of the present invention.

The printing member and the imaging system of the present invention may be any suitable ones, one example being the ones disclosed in PCT Patent Application PCT/IL97/00028 the content of which is incorporated herein by reference.

The CTP system of the present invention can be associated with the printing member inspection system disclosed in coassigned U.S. patent application 08/275,902 the content of which is incorporated herein by reference enitled AUTOMATIC INSPECTION OF PRINTING PLATES OR CYLINDERS. In the illustrated embodiment, this optional inspection unit is referenced by numeral 11.

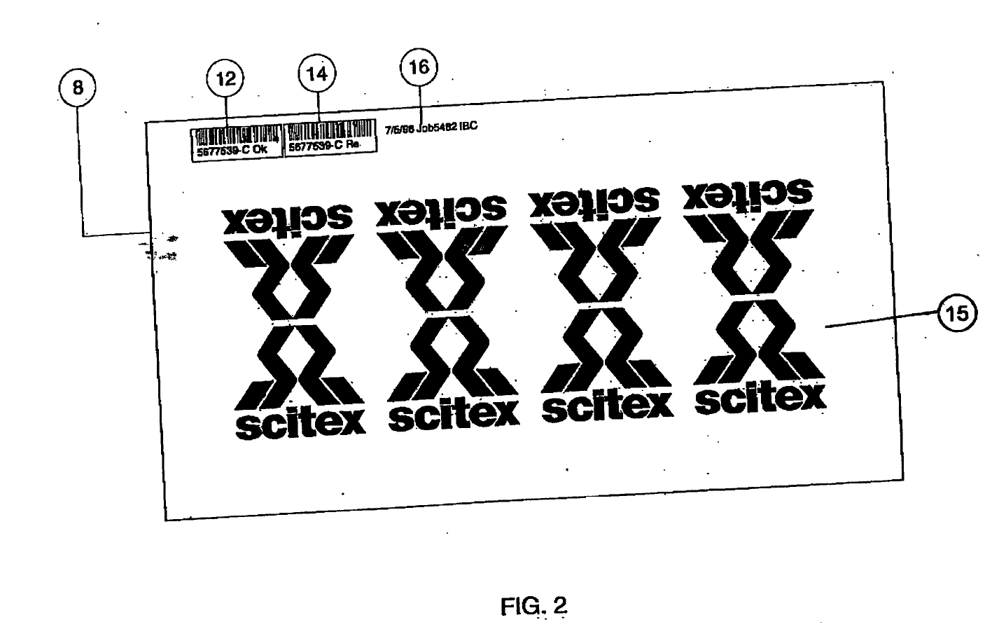

In accordance with a preference embodiment of the present invention, a code is exposed alongside the content image to be printed by plate setter 6 as illustrated in FIG. 2 which is a detailed illustration of printing member 8, to which reference is now also made. In the illustrated embodiment, the code comprises an “ID” bar code 12, a status bar code 14 and the user plate (or job) identification (ID) details 16. The code details are printed alongside the plate's image 15.

Each printing member comprises at least one bar code, that is, the ID bar code 12. The status bar codes 14 can be prepared separately and need not be prepared at the time the printing member is initially produced.

Each printing output material (proof, improof, plate, film) that is produced from the front end 4 is exposed with a unique bar code. This bar code which is generated by the front end 4, is linked to all the output material's relevant files. The files together with the expose/proof parameters are then kept ready for re-use at a designated digital archive 5 or in the front end 4.

When output media 8 is produced, it is imaged with a bar code as a part of its identification label. The bar code can be divided into several parts that can be read into the front end 4 using optical reader 11 and provide the front end with both the data identification and its status. Each change of status is recorded and another bar code is generated. Thus for a printing member which has undergone several processes and has been subject to remake, for example, the output media will contain several status bar codes. In an alternative embodiment, the output media only shows the ID bar code 12. The status bar codes 14 related to the ID bar code 12 can be stored separately in a different location, for example, in a look-up table. Whenever, the ID bar code 12 is read, the related status information is automatically accessed.

As shown in the illustrated embodiment of FIG. 2, the coded information is displayed alphanumerically or as a bar code. The plate details (16), which enable the front end to identify the output material proof, improof, film or plate) and its corresponding digital files, is shown alphanumerically. A two part bar code 12 and 14 convey the ID and status of the output material. Thus, with the identificaton details 16, ID code 12 and the status of the output material 14, the front end can automatically perform a pre-planned section of the work flow, such as approve/fail proofs, re-expose plates, move files to storage, and retrieve files from storage.

The changing status of a printing member (for example purposes only, a single bar code 14 is illustrated in FIG. 2) is shown by a plurality of bar codes, each bar code reflecting a different stage in the workflow. For example, a particular plate may have two bar codes; a “remake” status bar code indicating that the plate is damaged and a remake should be carried out and a second “OK” status bar code indicating that this specific plate or printing member has been produced without defects or errors. Examples of various status reports are described hereinbelow. Each bar code may contain detailed information for each status, for example, details of the type and extent of the correction necessary for a “remake” status.

In operation the front end gathers all the digital image files in the front end module 4. The front end then triggers the front end module 4 from the front end console 2 to convert the image data into a raster image, and afterwards, to drive the raster data to the plate setter 6 in order to expose the data to the plate 8.

After the plate is exposed and processed, it is mounted on the offset press machine 9. If all goes well, after the printing is finished, the printer can read the plate's code and the “OK” status 12 are read into the front end module 4 by the bar code optical reader 11. All the image files, raster image processing and exposure parameters, are then sent to the digital archiver 5 for archiving or erased from the front end if the data is not preset for archiving.

During production, there are many ways that the plate 8 can get damaged or corrupted. For example, if the plate setter 6 malfunctions, the front end operator will have to fix the problem with the plate setter 6 and initiate exposure again. Damage can occur to the plate after exposure; during or after processing of the plate 8 or when the plate is mounted on to the press.

After removing the cause of the damage, the press operator can read the plate's code and the “Remake” status into the front end module 4 with the bar code optical reader 11. The front end module 4 will automatically intiate the reproduction of the damaged plate and expose all the image data, with the same exposure parameters, to the plate setter 6. This process can be set so that no access to the front end console 2 is necessary to initiate the plate remake procedure.

When a plate is damaged, a plate remake can be requested by reading the plate's bar code and the status ‘remake’. The same plate as the damaged plate can be immediately exposed by any unskilled front end operators without accessing the front end.

Non-limiting examples of the status reports which can be made with the aid of bar codes, Is illustrated in the following table:

| Status | Description |
|---|---|
| ‘Proof approved’ | A proof status that indicates that the proof is |
| | approved |
| ‘Proof Failed’ | A proof status that indicates that the proof has |
| | failed. |
| ‘Film/Plate OK’ | A report to the prepress system that this specific |
| | plate has been produced without defects or |
| | errors. |
| ‘Film/Plate Remake’ | This status enables any unskilled press operator |
| | to automatically initiate a “film/plate remake” |
| | procedure when a film/plate is damaged. |
| | A copy of the same film/plate as the damaged |
| | plate can be immediately exposed without |
| | accessing the front end. |
| ‘Plate removed’ | The plate is removed from the press and the |
| | printing is finished. The digital files can be sent |
| | to a digital archive for “long term” archiving or |
| | erased. |

Another advantage of using bar codes on output media, is long-term plate archiving. The bar code can be read from a damaged plate which has been stored in a plate archive for a long period, in order to reproduce a copy of the plate. When the plates are not stored, or when the plates are missing, the plate codes can be kept in a “paper” archive (preferably with a sample of the job), or be exposed as part of the job (for example; on the last page of a book), so that files and expose parameters can automatically be retrieved from archiving, and the plates re-exposed for re-printing.

In order to reprint the plates, the bar codes are read by the bar code optical reader into the front end, thus enabling the files and exposure parameters to be automatically retrieved from archiving so that the plates can be re-exposed for re-printing.

The plate's generated codes can also be used to produce a coded index for a printing job. If a job needs to be re-printed, and some of the plates are damaged or missing after having been archived, the bar codes (12, 14) appearing on the plates can be read by the bar code optical reader 11 into the front end module 4. The bar codes can be read either directly from the damaged plate or from the printed material which will be printed with a copy of the plates' codes. The plate's codes can be used by the front end module 4 to retrieve image files and exposure parameters from the digital archiver 5 for the front end module 4. The image data can then be immediately sent to the plate setter 6 to produce a copy of the plates of the printed job.

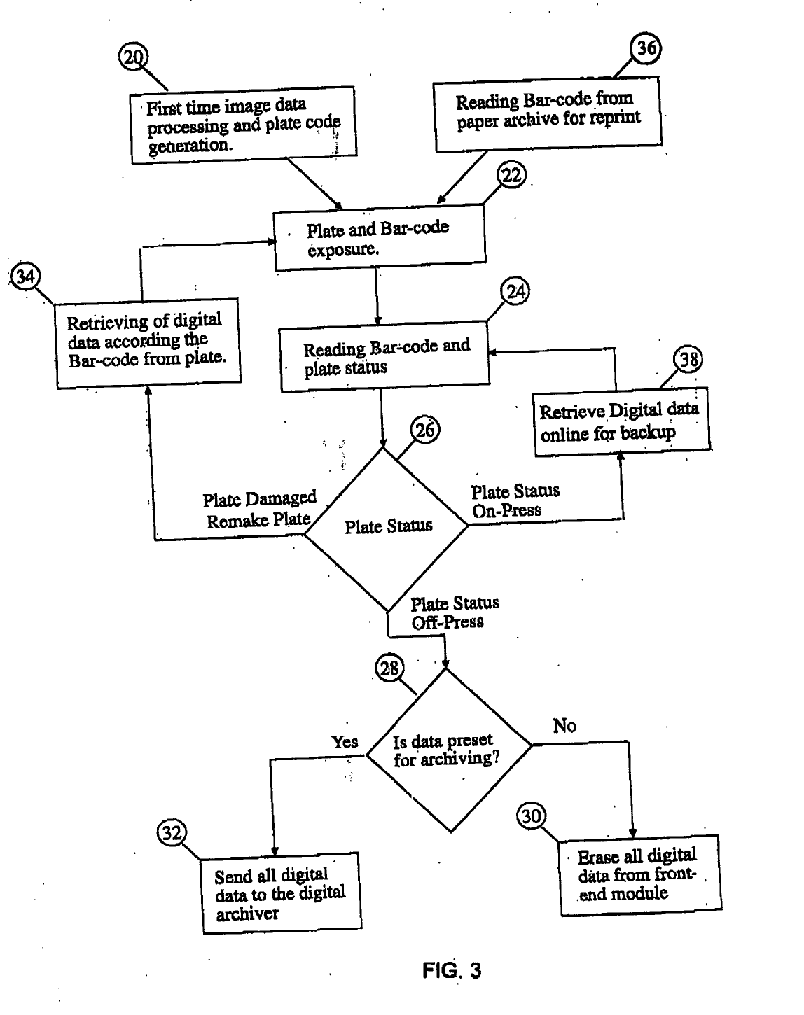

Reference is now made to FIG. 3 which is a flow chart illustration of the automatic remake process operative in accordance with a preferred embodiment of the present invention.

For first time image data processing, the digital information representation of the content image 15 is generated (step 20) in the manner well known in the prepress industry. Concurrently, the bar codes 12 and 14 are generated. In the example of the illustrated embodiment, the “OK” bar code 12 and remake bar code 14 are bar codes generated similarly to bar codes in other applications used in the prior art. Any suitable code generation method may be used.

Alternatively, if a reprint is being made, the bar code is read from the archive (step 36), before exposure (step 22).

After the plate and bar code have been exposed (step 22), the bar code and plate are read (step 24) to record the plate status in the memory of front end 4.

The printing member is inspected for defects either automatically using the system of the above mentioned '902 patent application, for example, or manually by physical inspection of the plate after exposure or simply by receiving unsatisfactory printing results provided by press 9.

Depending on the plate's status, a decision is made (module 26) whether to initiate a plate re-exposure. If the plate is not OK a remake procedure is activated as indicated by the loop of steps 34 and 22-26. A particular feature of the present invention is that if the remake code is activated the retrieval and re-exposure of the plate is automatically initiated by front end 4 by associating the code with the data representing the data for the image to be exposed. This is extremely advantageous as any inexperienced operator can initiate the plate re-make process. All the imaging data and exposure parameters are retrieved either from the digital archive 5 or the disc on the front end 4.

If the plate status is ‘plate On-press’, the front end prepares the image files for backup on a local disk 38 and waits for another status report.

If the plate is OK and the plate status is off-press, re-make is not required and the digital data representing the content image 15 on plate 8 can be archived in digital archiver 5 with its code for future easier retrieval as indicated by steps 28 and 32 or can be erased as indicated by steps 28 and 30.

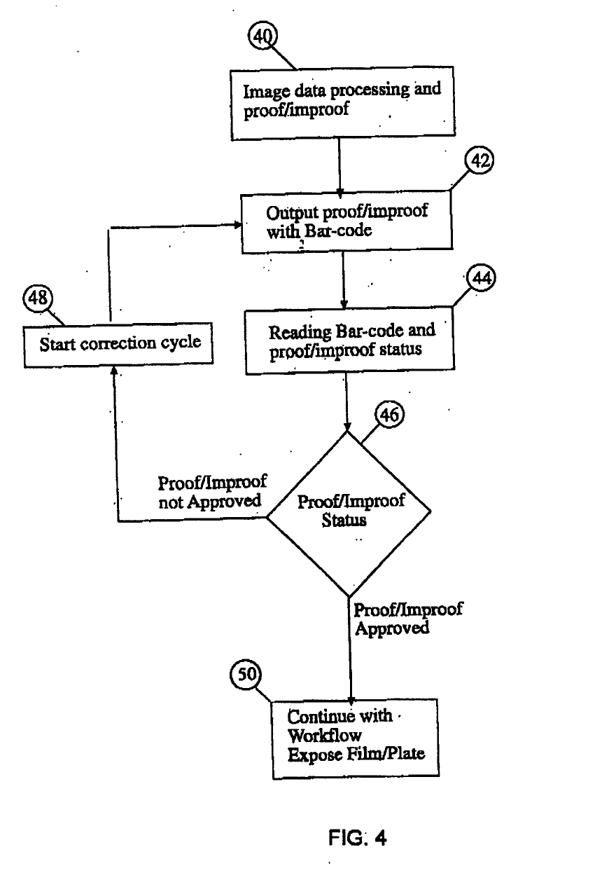

FIG. 4, to which reference is now made, describes the use of bar codes with proofs/improofs as part of the prepress workflow.

The digital information representation of the proof/improof is generated (step 40) in the manner well known in the prepress industry. Concurrently, the proof/improof bar codes are output (step 42). The proof/improof bar codes are similar to the “OK” bar code 12 and remake bar code 14 of the plates described hereinabove.

Then, the bar code and proof/improof status are read (step 44) to record their status at the front end 4.

The proof/improof is inspected for defects and depending on the status, a decision is made (module 46) whether to continue (step 50) and expose the plate, as described here in above with respect to FIG. 3. If the proof/improof is not OK a correction procedure is activated as indicated by the loop of steps 48 and 42-46.

It will be appreciated by persons skilled in the art that the present invention is not limited to what has been particularly shown and described hereinabove. For example, the printing members of the present invention need not be plates and may be films or proofs and accordingly the system will include a plotter and a proofer, respectively. Rather, the scope of the present invention is defined only by the claims that follow:

1. A method for producing a printing member acceptable for printing comprising:
exposing a first printing member with a code associated with the digital data representing the content image thereof;
determining whether said first printing member meets a quality suitable for printing; and
remaking said printing member to expose a second printing member utilizing said code to retrieve said digital data representing the content image.

2. A method according to claim 1 wherein said step of exposing, includes exposing said first printing member by a plate setter or on-press.

3. A method according to claim 1 wherein said determining comprises inspecting said first printing member to determine its quality.

4. A method according to claim 3 wherein said inspecting is automatic or manual.

5. A method according to claim 1 also comprising the step of archiving said data representing the content image along with said code in any of a group of archiving units including a digital archiver, paper archiver or indexing system.

6. A method according to claim 1 also comprising the step of storing said data representing the content image along with said code at the front end of a computer to press (CTP) printing system.

7. A method according to claim 6 wherein said step of storing comprises the step of reading said data.

8. A method according to claim 1 wherein said code is a bar code.

9. A method according to claim 8 wherein said code further comprises at least one additional bar code to identify the status of the printing member.

10. A method according to claim 9 wherein reading said ID portion and said status portion triggers a prepress procedure.

11. A method according to claim 9 wherein said status is an “archive” status and wherein reading said ID portion and said archive status portion triggers said archiving.

12. A method according to claim 9 wherein said status is a “remake” status and wherein reading said ID portion and said remake status portion triggers the remake of said printing member.

13. A method according to claim 1 wherein said utilizing comprises reading said code of said first printing member, thereby triggering the retrieval of said digital data representing the content image.

14. A method according to claim 13 wherein said reading of said code further comprises the step of retrieving the status of said printing member.

15. A method according to claim 5 wherein said remaking comprises reading said code from said archived data.

16. A method according to claim 6 wherein said remaking comprises reading said code from said stored data.

17. A method according to claim 16 wherein reading said code automatically activates the retrieval and exposure of said printing member.

18. A method according to claim 1 and further comprising the step of:
preparing a proof or improof prior to said step of exposing said printing member.

19. A method according to claim 18 wherein said preparing a proof comprises the steps of
exposing said proof with a code associated with the digital data representing the proof image thereof and the status of said proof;
determining whether said proof meets a qualify suitable for printing; and
if said proof is not approved, correcting said proof.

20. A method according to claim 18 wherein said step of exposing said printing member includes the step of utilizing said code representing the proof image.

21. A printing member produced in accordance with the method of claim 1.

22. A computer to press (CTP) system for producing a printing member acceptable for printing comprising:
means for exposing a first printing member with a code associated with the digital data representing the content image thereof;
means for determining whether said first printing member meets a quality suitable for printing; and
means for remake said printing member to expose a second printing member utilizing said code to retrieve said digital data representing the content image.

23. A system according to claim 22 wherein said means for exposing including an imaging system of a plate setter or a digital printing press.

24. A system according to claim 22 wherein said means for determining comprises an inspection unit for inspecting said first printing member to determine its quality.

25. A system according to claim 24 wherein said inspection unit is automatic or manual.

26. A system according to claim 22 also comprising a digital archiving system for archiving said data representing the content image along with said code.

27. A system according to claim 22 also comprising a front end module for storing said data representing the content image along with said code.

28. A system according to claim 22 wherein said means for remake utilizes a code reader for reading said code of said first printing member, thereby triggering the retrieval of said digital data representing the content image.

29. A system according to claim 27 wherein said front end automatically activates the retrieval and exposure of said printing member.

30. A system according to claim 22 wherein said code is a bar code.

31. A method according to claim 30 wherein said code further comprises at least one additional bar code to identify the status of the printing member.

32. A method according to claim 31 wherein reading said ID portion and said status portion triggers a prepress procedure.

33. A method according to claim 31 wherein said status is an “archive” status and wherein reading said ID portion and said archive status portion triggers said archiving.

34. A method according to claim 31 wherein said status is a “remake” status and wherein reading said ID portion and said remake status portion triggers the remake of said printing member.

35. A system according to claim 22 and further comprising means for exposing a proof or improof prior to exposing said first printing member.

36. A printing member produced by the system of claim 22.
